(19) United States
(12) Patent Application Publication
(10) Pub. No.: US 2014/0101998 A1
(43) Pub. Date: Apr. 17, 2014

(54) PASSIVE WATER SUPPLY SYSTEM FOR PLANT POT

(71) Applicant: CHIN-TAI TSAI, TAICHUNG CITY (TW)

(72) Inventor: CHIN-TAI TSAI, TAICHUNG CITY (TW)

(21) Appl. No.: 14/105,536

(22) Filed: Dec. 13, 2013

Related U.S. Application Data
(62) Division of application No. 13/244,515, filed on Sep. 25, 2011.

(30) Foreign Application Priority Data
Jan. 25, 2011 (TW) 100120263
Jul. 12, 2011 (TW) 100124524

(51) Int. Cl. A01G 9/02; A01G 27/02

(52) U.S. Cl. CPC A01G 9/02; A01G 27/02
USPC 47/79

(57) ABSTRACT

A pot assembly includes a pot having an inner part and an outer part which supports the inner part. A hollow area is defined between the inner and outer parts, and a recessed space is defined between an inner bottom and the periphery of the inner part. At least one hole is located at a position of the space and communicates with the hollow area. A water-guide member includes multiple particles, and irregular paths are defined between the particles. The water-guide member is located at traces between the space and the at least one hole. Liquid in the hollow area slowly spreads upward into the soil in the space by way of the surface tension and the paths. The owners do not need to water the plants frequently.

### FIELD OF THE INVENTION

The present application is a divisional application of applicant's prior patent application with the application Ser. No. 13/244,515, filed on Sep. 25, 2011.

### BACKGROUND OF THE INVENTION

The conventional pot for plants generally is made by ceramic or plastic which is made integrally by way of mold injection and includes a single layer, and a recessed area is defined in the center thereof and a hole is defined through the bottom of the pot. The soil is filled in the recessed area and the exceed water in the soil can escape from the hole in the bottom of the pot so that the soil is maintained in suitable water for providing good conditions for the plants in the pot.

However, during the growing process of the plant in the pot, the owner has to water proper amount of water to the plant. Most of the owners believe that more water supplied to the plants is better than less water so that usually the exceeded water and the soil flow from the hole of the pot. The soil and water make the floor messy and the soil flows from the pot quickly.

Furthermore, urban people live in high rise buildings so that the watering to the plants may cause water drop to the lower floors and this generally generates noise and the neighbors lived in the low floors may feel upset by the leaking water and soil.

The conventional pot has only one layer so that the heat from the sunshine is directly transferred to the plant of the pot so that the temperature and humidity at the bottom of the pot is too high so that the roots of the plants easily die.

When the owners travel away from homes, the plants can easily die because of lack of water.

The present invention intends to provide a hollow pot with a water supply system to improve the shortcomings mentioned above.

### SUMMARY OF THE INVENTION

The present invention relates to a pot assembly and comprises a pot having an inner part and an outer part which supports the inner part. A hollow area is defined between the inner and outer parts. A recessed space is defined between the inner bottom and the periphery of the inner part. At least one hole is located at a position of the space and communicates with the hollow area. A water-guide member comprises multiple particles, and irregular paths are defined between the particles. The water-guide member is located at traces between the space and the at least one hole.

Preferably, the water-guide member comprises multiple metal particles which are made by way of sintering, and irregular paths are defined between the metal particles. An end of the water-guide member extends through the at least one hole and reaches into the hollow area.

Preferably, the metal particles are copper particles.

Preferably, the water-guide member comprises multiple ceramic particles which are made by way of sintering, and irregular paths are defined between the particles. An end of the water-guide member extends through the at least one hole and reaches into the hollow area.

Preferably, the water-guide member comprises multiple stone particles which are made by way of sintering, and irregular paths are defined between the particles. An end of the water-guide member extends through the at least one hole and reaches into the hollow area.

The present invention supplies water to the soil so as to adjust the humidity of the soil within a long term of time such that the roots of the plants are not rotten. The hollow area of the pot assembly is used as a water storage area and the water can be spread and guided into the soil in a small amount to keep the soil wet so that the owners do not need to water the plants frequently. This allows the owners of the plants to travel away from home for a period of time without worry of watering of the plants.

The transparent outer part has the over-flow index area on the outside thereof and the sun rays directly enter the hollow area so that the maximum level of water, the humidity of the soil, the growth of the plants and the way of the water flow can be visible by the owners. Aquatic plants and animals can be raised in the hollow area to achieve aesthetic purposes.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the pot assembly of the present invention;

FIG. 2 is a cross sectional view of the pot assembly of the present invention;

FIG. 3 is a partial enlarged cross sectional view of the pot assembly of the present invention in FIG. 2, and

FIG. 4 is a cross sectional view to show a way of use of the pot assembly of the present invention.

### DETAILED DESCRIPTION OF THE PREFERRED EMBODIMENT

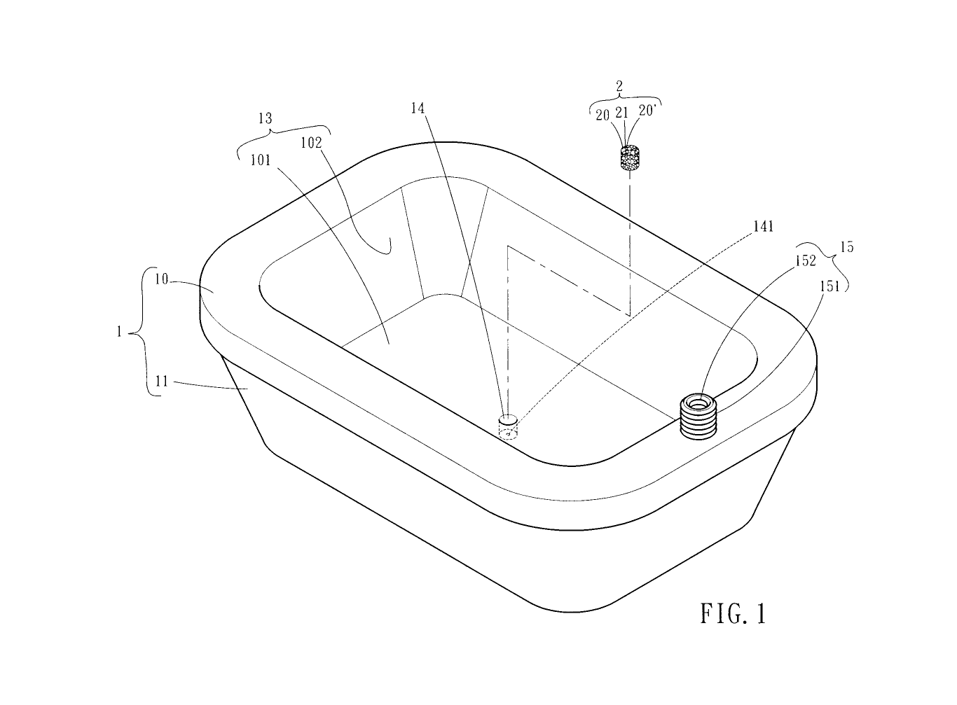

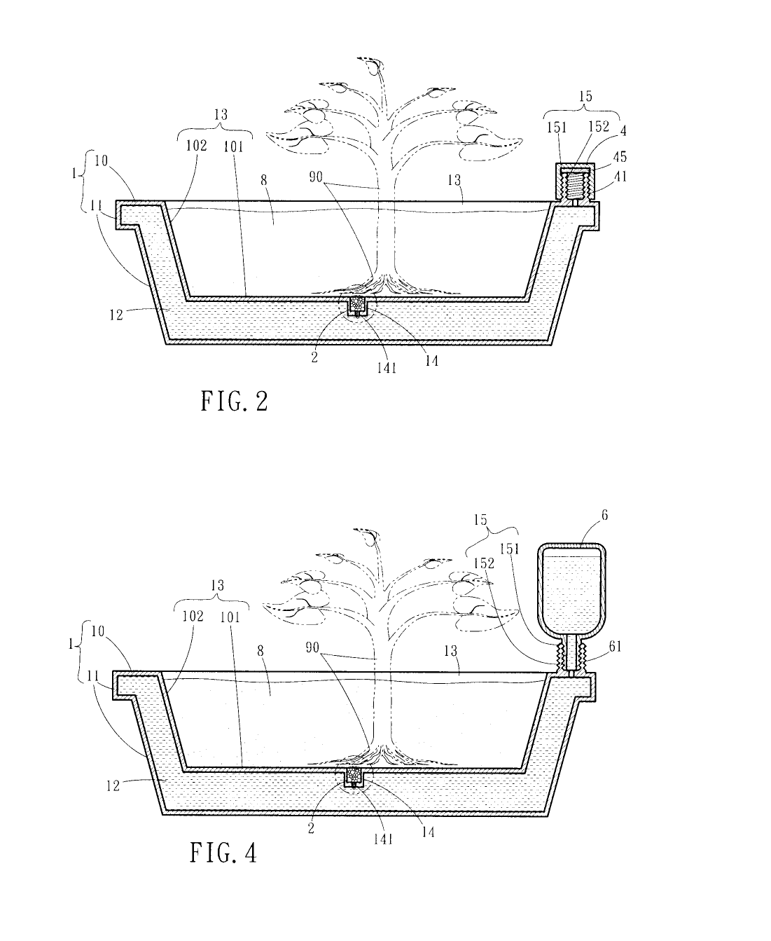

Referring to FIGS. 1 to 4, the pot assembly of the present invention comprises a pot 1 and a water-guide member 2, wherein the pot 1 has an inner part 10 with a recessed space 13 defined therein, and an outer part 11 which supports the inner part 10. A hollow area 12 is defined between the inner and outer parts 10, 11, and a water-supply unit 15 is connected to the hollow area 12. The space 13 is defined by the inner bottom 101 and the periphery 102. The inner bottom 101 has a downward recess 14 with one stage or multiple stages. At least one hole 141 is located at a position of the space 13 and communicates with the hollow area 12. The inside of the recess 14 is located outside of the water-guide member 2 so that the hole 141 communicates between the recess 14 or the space 13 and the hollow area 12. An end of the water-guide member 2 extends through the hole 141 and the water-guide member 2 comprises multiple particles 20, 20′. In other words, the end of the water-guide member 2 extends through the lower opening of the hole 141 or protrudes from the bottom of the hole 141. Preferably, the end of the water-guide member 2 extends beyond the lower opening of the hole 141 and reaches into the hollow area 12. The lowest position of the recess 14 or the hole 141 is located at the inside of the horizontal line of the lowest position of the inner bottom 102, or slightly protrudes beyond the inside of the horizontal line of the lowest position of the inner bottom 102 about 10 mm, so that the recess 14 or the hole 141 is hidden. The water-supply unit 15 is a hollow unit and has one end extends through the inner pat 10 or the outer part 11, and communicates with the hollow area 12. The water-supply unit 15 has a locking portion 151 and inner threads 152 at an inside thereof so that the seal unit 4 (including cover or cap) can be threadedly connected to the outside or the inside of the water-supply unit 15. A sealing member 45 (such as a washer or gasket) is located between the seal unit 4 and the water-supply unit 15. Therefore, the hollow area 12 is sealed by the seal unit 4, such as the cover in FIG. 2 and the sealing member 45. The locking portion 151 can be hooked or spiral shape. The inner part 10 and the outer part 11 of the pot 1 are integrally connected to each other by way of blow molding as shown in FIGS. 2 and 4, or by way of blow-mounting-molding, or the two parts 10, 11 are individually made and then connected to each other.

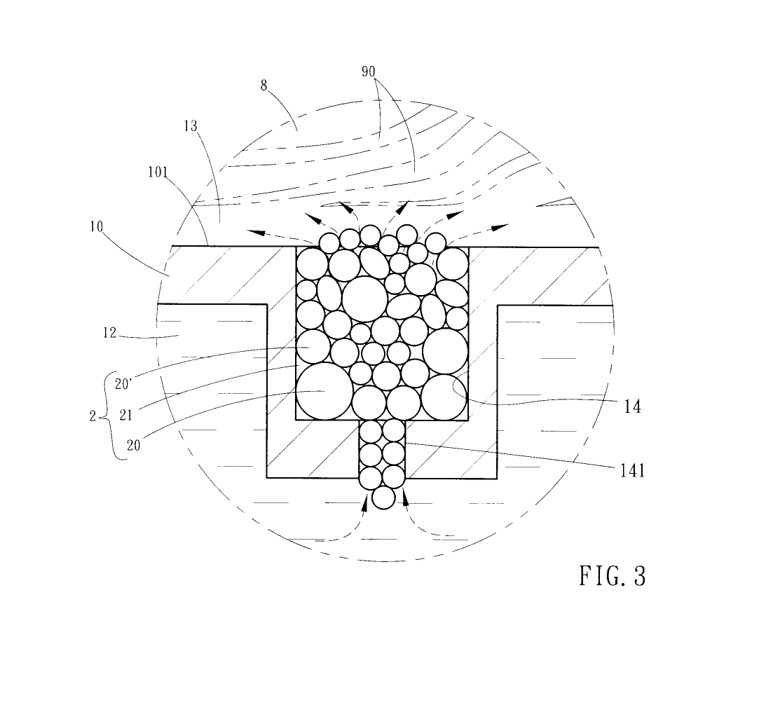

The water-guide member 2 comprises multiple particles 20, 20′ which are made by way of sintering. Irregular paths 21 are defined between the particles 20, 20′. The particles 20, 20′ are not rotten in the water such as metal particles (such as iron particles, silver particles, Tin particles, and copper particles). Stone particles, ceramic particles are also available. The copper particles 20, 20′ are preferable. As shown in FIG. 3, the outer surface or inside of the water-guide member 2 comprises multiple metal particles, preferable copper particles, which are made by way of sintering. Irregular paths 21 are defined between the particles 20, 20′. The water-guide member 2 is located in the recess 14 between the space 13 and the hollow area 12. An end of the water-guide member 2 extends through the conjunction area between the hole 141 and the hollow area 12, or the end of the water-guide member 2 extends through the hole 141 and reaches into the hollow area 12. Liquid in the hollow area 12 slowly spreads upward into the soil 8 in the space 13 by way of the surface tension and the paths 21.

The seal unit 4 is an individual unit and has inner threads 41 (or hooks) defined in the inside thereof and the sealing member 45 is located at the bottom of the seal unit 4. The seal unit 4 is connected to the water-supply unit 15 by the inner threads 41 and the sealing member 45 is firmly clamped between the end surface of the water-supply unit 15 and the seal unit 4.

When planting the plant 90, the metal water-guide member 2 is installed in the hole 141 in the recess 14 and the other end of the water-guide member 2 extend through the hole 141 and reaches into the hollow area 12, so that the water-guide member 2 is located at water traces between the space 13 and the at least one hole 141. Because the water-guide member 2 comprises multiple metal (copper) particles 20, 20′ which are made by way of sintering and have irregular paths 21 defined between particles 20, 20′, so that the hollow area 12 and the space 13 are in communication with each other. Soil 8 is poured into the space 13 and the plant 90 is planted into the soil 8. Watering the soil 8 and the water spreads the soil 8 and is eventually collected in the hallow area 12 so that the exceed water in the soil 8 flows into the hollow area 12 via the paths 21 between the particles 20, 20′. The exceed water is stored in the hollow area 12 to adjust the humidity of the soil 8 and does not leak.

Water can also be poured into the hollow area 12 via the water-supply unit 15 until the surface of the water in the hollow area 12 reaches the bottom of the recess 14. The water enters into the soil 8 by way of surface tension via the hole 141 and the paths 21 of the water-guide member 2. The water slowly spreads the soil via the hole and the paths 21 and fills the area between the recess 14 and the water-guide member 2. The soil 8 located close to the surface of the water-guide member 2 is slightly wet. When water is continuously supplied from the water-supply unit 15, the surface of the water in the hollow area 12 raises until the surface reaches the maximum position. The inner threads 41 or the outer threads 42 of the seal unit 4 is threadedly connected to the locking portion 151 or the inner threads 152 to let the seal unit 4 properly connected to the water-supply unit 15.

Because the seal unit 4 and the water-supply unit 15 are not completely sealed, small amount of air enters from the gaps between the seal unit 4 and the water-supply unit 15. Therefore, the small amount of air applies a pressure to the water surface in the hollow area 12 so as to force the water molecular slowly flows into the soil 8 via the gaps between the hole 141 and the water-guide member 2, until the soil 8 cannot absorb more water. In other words, the water molecular can be automatically supplied to the soil 8 via the gaps between the hole 141 and the water-guide member 2, and this keeps the plant alive even if the owners travel way from home for a period of time. Furthermore, irregular paths 21 are defined between the particles 20, 20′ of the water-guide member 2 and the multiple metal particles (copper particles) are made by way of sintering. These particles are not rotten in the water and the paths 21 are not stocked by the soil 8 so that the paths 21 are ensured to be functioned properly to keep the humidity of the soil 8 in the space 13 and filter the water passing through the paths 21.

Referring to FIG. 4, a water bottle 6 can be used to be connected to the water-supply unit 15 by threadedly connected the threads 61 of the water bottle 6 to the inner threads 152 of the water-supply unit 15. The water bottle 6 has water received therein so as to perform as a water source to the hollow area 12. While we have shown and described the embodiment in accordance with the present invention, it should be clear to those skilled in the art that further embodiments may be made without departing from the scope of the present invention.

What is claimed is:

1. A pot assembly comprising:
a pot having an inner part and an outer part which supports the inner part, a hollow area defined between the inner and outer parts, a recessed space defined between an inner bottom and a periphery of the inner part, at least one hole located at a position of the space and communicating with the hollow area, and
a water-guide member comprising multiple particles, irregular paths defined between the particles, the water-guide member located at traces between the space and the at least one hole.

2. The pot assembly as claimed in claim 1, wherein the water-guide member comprises multiple metal particles which are made by way of sintering, irregular paths are defined between the metal particles, an end of the water-guide member extends through the at least one hole and reaches into the hollow area.

3. The pot assembly as claimed in claim 2, wherein the metal particles are copper particles.

4. The pot assembly as claimed in claim 1, wherein the water-guide member comprises multiple ceramic particles which are made by way of sintering, irregular paths are defined between the particles, an end of the water-guide member extends through the at least one hole and reaches into the hollow area.

5. The pot assembly as claimed in claim 1, wherein the water-guide member comprises multiple stone particles which are made by way of sintering, irregular paths are defined between the particles, an end of the water-guide member extends through the at least one hole and reaches into the hollow area.
